(19) United States
(12) Patent Application Publication
(10) Pub. No.: US 2008/0130532 A1
(43) Pub. Date: Jun. 5, 2008

(54) Packet radio communication device

(75) Inventor: Jani J. Maenpaa, Kaivanto (FI)

Correspondence Address: SQUIRE, SANDERS & DEMPSEY L.L.P., 8000 TOWERS CRESCENT, 14TH FLOOR, TYSONS CORNER, VA, 22182-2700, US

(73) Assignee: Nokia Corporation

(21) Appl. No.: 11/723,351

(22) Filed: Mar. 19, 2007

(30) Foreign Application Priority Data
Nov. 30, 2006 (FI) 20065765

(51) Int. Cl. H04B 7/00

(52) U.S. Cl. 370/310

(57) ABSTRACT

A computer may be provided with a wireless communication capability by connecting a communication device to the computer through a cable connection. The communication device may provide the computer with a communication connection to a mobile telecommunication network. When a cable connecting the communication device to the computer is removed, the communication device detects a disconnection between the communication device and the computer. Consequently, the communication device starts a timer upon detection of the disconnection and performs an operation to deregister the communication device from the mobile telecommunication network after the lapse of a pre-determined time period counted by the timer. Accordingly, the communication device does not immediately deregister itself from the mobile telecommunication network when it detects the disconnection. Instead, the communication device allows a user to reattach the cable within the pre-determined time period. Thus, unnecessary signaling between the communication device and the mobile telecommunication network is avoided.

### FIELD

The invention relates to a packet radio communication device providing an electronic device such as a computer with a packet radio communication capability.

### BACKGROUND

In order to provide a computer with a wireless communication capability, a communication device may be integrated into or connected to the computer. Such a communication device may be a network adapter providing a wireless communication connection to a base station or another transceiver communicating according to IEEE 802.11 standard, i.e. Wireless Local Area Network (WLAN). A problem with WLAN connections is limited coverage and, as a result, limited mobility.

Therefore, network adapters providing a wireless connection to a network of a mobile telecommunication system providing a data radio service have been widely used. Such a mobile telecommunication system may be 2^{nd} or 3^{rd} generation mobile telecommunication system providing a much wider coverage than scattered WLAN hotspots. The network adapter providing the wireless connection to the mobile telecommunication system may be connected to a Personal Computer Memory Card International Association (PCMCIA) slot of the computer, for example.

Instead of arranging a network adapter to provide the computer with a computer connection, a mobile telephone of the mobile telecommunication system may be connected to the computer to enable data transfer between the computer and the Internet through the mobile telecommunication system. The mobile phone may be connected to the computer via cable or wirelessly over a Bluetooth® connection, for example. The connection between the mobile phone and the computer is a dial-up connection which is more complex to establish and operate than the connection between the network adapter and the computer.

Furthermore, a wireless short-range communication scheme, such as Bluetooth®, may not provide data rates as high as modern packet radio services provided by mobile telecommunication systems such as Universal Mobile Telecommunication System (UMTS) based on wideband code division multiple access (W-CDMA) technology or systems providing ever higher data rates, such as those developed in the 3^{rd} Generation Partnership Project (3GPP). Moreover, the wireless short-range connections are unreliable because they usually operate on unlicensed frequency bands, and their performance may be degraded by other signals located on the same frequency bands. Therefore, the cable connection remains an alternative for connecting the communication device to the computer. A problem with cable connections, however, is that the cable may be removed accidentally, thereby causing a disconnection between the communication device and the computer. This results in a disruption of data transfer between the computer and the mobile communication network and may even cause a disconnection in the communication link between the communication device and the mobile telecommunication network.

### BRIEF DESCRIPTION OF THE INVENTION

An object of the invention is to provide an improved solution for controlling the operation of a communication device providing an electronic device with a wireless communication capability.

According to an aspect of the invention, there is provided a method. The method comprises detecting a disconnection between an electronic device and a communication device providing the electronic device with a communication connection to a mobile telecommunication network, starting a timer upon detection of the disconnection between the electronic device and the communication device, and performing an operation to disconnect the communication connection between the communication device and the mobile telecommunication network after the lapse of a pre-determined time period counted by the timer.

According to another aspect of the invention, there is provided an apparatus, comprising a first interface to provide a connection to an electronic device, a second interface to provide a connection to a mobile telecommunication network, and a processing unit configured to detect a disconnection in a first interface, start a timer upon detection of the disconnection in the first interface, and perform an operation to disconnect the second interface from the mobile telecommunication network after the lapse of a pre-determined time period counted by the timer.

According to another aspect of the invention, there is provided an arrangement, comprising an electronic device comprising an interface to provide a communication connection with peripheral devices and a processing unit configured to control the operations of the electronic device, and a communication device comprising a first interface to provide a connection to the electronic device, a second interface to provide a connection to a mobile telecommunication network, and a processing unit configured to detect a disconnection in the connection with the electronic device, start a timer upon detection of the disconnection in the connection with the electronic device, and perform an operation to disconnect the second interface from the mobile telecommunication network after the lapse of a pre-determined time period counted by the timer.

According to another aspect of the invention, there is provided a computer program product encoding a computer program of instructions for executing a computer process. The computer process comprises detecting a disconnection between an electronic device and a communication device providing the electronic device with a communication connection to a mobile telecommunication network, starting a timer upon detection of the disconnection between the electronic device and the communication device, and performing an operation to disconnect the communication connection between the communication device and the mobile telecommunication network after the lapse of a pre-determined time period counted by the timer.

According to another aspect of the invention, there is provided a computer program distribution medium readable by a computer and encoding a computer program of instructions for executing a computer process. The computer process comprises detecting a disconnection between an electronic device and a communication device providing the electronic device with a communication connection to a mobile telecommunication network, starting a timer upon detection of the disconnection between the electronic device and the communication device, and performing an operation to disconnect the communication connection between the communication device and the mobile telecommunication network after the lapse of a pre-determined time period counted by the timer.

### LIST OF DRAWINGS

In the following, the invention will be described in greater detail with reference to the embodiments and the accompanying drawings, in which

FIG. 1 illustrates an arrangement for providing a computer with a wireless communication connection according to an embodiment of the invention;

FIG. 2 illustrates block diagrams of devices in the arrangement according to the embodiment of the invention illustrated in FIG. 1;

FIG. 3 illustrates a signaling diagram illustrating operations carried out in a communication device according to an embodiment of the invention;

FIG. 4 illustrates another signaling diagram illustrating operations carried out in the communication device according to an embodiment of the invention;

FIG. 5 is a flow diagram illustrating a process for controlling the operation of the communication device according to an embodiment of the invention.

### DESCRIPTION OF EMBODIMENTS

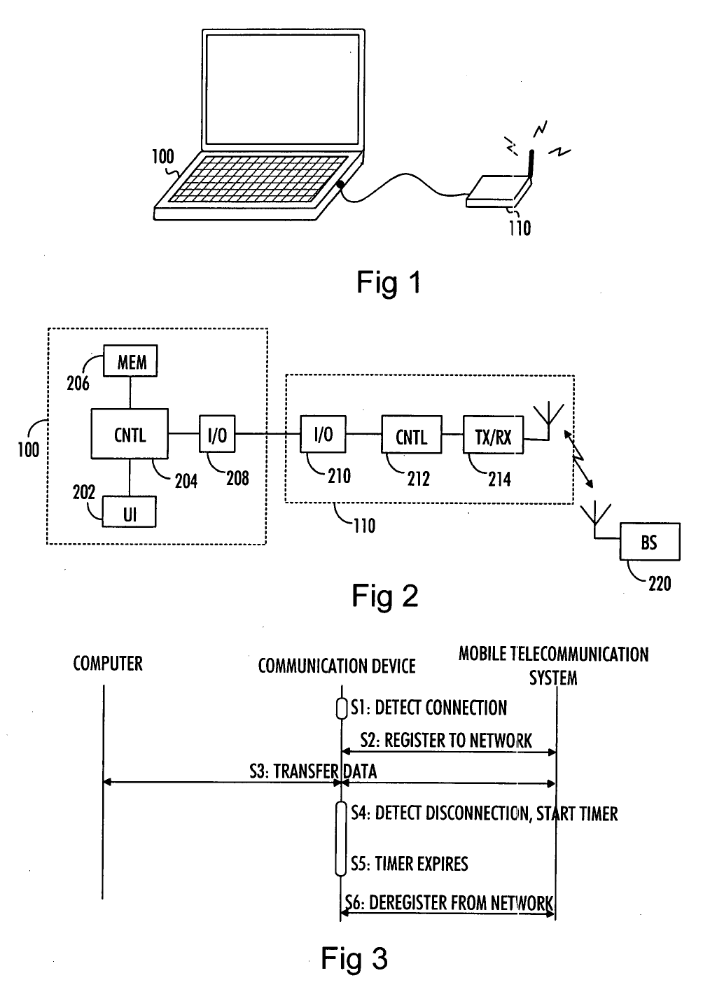

FIG. 1 illustrates an arrangement for providing an electronic device 100 with a wireless communication connection according to: an embodiment of the invention. The electronic device 100 may be, for example, a (portable) computer connected to a communication device 110 providing the computer with the wireless communication connection. While the computer is used as an example of the electronic device 100 in the following description, the electronic device 100 may be another type of an electronic device. The communication device 110 may be an external peripheral device connected to the computer 100 through a wired connection. The communication device 110 may be connected to a Universal Serial Bus (USB) port of the computer 100 and it may communicate with the computer 100 according to Remote Network Driver Interface Specification (RNDIS). Accordingly, the communication device 110 may function as a network adapter for the communication with the computer 100. As a result, no complex dial-up connections are required when a mobile phone is to be connected to the computer for a wireless communications capability.

The communication device 110 may provide the wireless communication connection to a mobile telecommunication system through a base station providing services in the neighborhood of the communication device 110. The base station belonging to the mobile telecommunication system may provide a high-speed packet radio service according to, for example, a Universal Mobile Telecommunication System (UMTS) Long-term Evolution (LTE), which is being standardized in the 3GPP. The high-speed packet radio service provided by the base station may also be another packet radio service.

FIG. 2 illustrates block diagrams of the computer 100 and the communication device 110 connected to the computer 100. Additionally, FIG. 2 illustrates a base station 220 configured to communicate with the communication device 110 wirelessly. The communication connection between the communication device 110 and the computer 100 may be a wired connection, as described above.

The communication device 110 may comprise a communication interface 214 to provide a radio connection with a base station 220 belonging to a mobile telecommunication network. The communication interface 214 may perform analog operations necessary for transmitting and receiving radio signals.

The communication device 110 may further comprise an input/output (I/O) interface 210 to provide a wired communication connection with the computer 100. Preferably, the I/O interface 210 may be connected to a USB port of the computer 100 via a cable connection, since the USB port provides the possibility to feed the communication device 110 with electrical power required for the operation of the communication device 110.

The communication device 110 may further comprise a processing unit 212 to control functions of the communication device 110. The processing unit 212 may handle the establishment, operation and termination of radio connections with the base station. The processing unit 212 may also handle the establishment, operation, and termination of wired connections with the computer 100. Additionally, the processing unit 212 may be configured to monitor at least the connection with the computer 100. The processing unit 212 may be implemented by a digital signal processor with suitable software embedded in a computer readable medium, or by separate logic circuits, for example with ASIC (Application Specific Integrated Circuit).

The computer 100 may comprise an I/O interface 208 to enable the computer 100 to communicate with peripheral devices connected to the computer 100. The I/O interface 208 may comprise physical ports where external devices may be connected. Such ports may include USB (version 1.1 or 2.0), Firewire, and RJ-45, among others. In order to utilize the high-speed radio connection provided by the communication device 110 and the mobile telecommunication system, the computer 100 preferably includes at least one port capable of providing a data rate equal to or higher than the data rate between the communication device 110 and the base station 220. The communication device 110 may be connected to such port. The I/O interface 208 may additionally comprise control logic to process signals to be transmitted and/or received through the ports of the I/O interface 208.

The computer 100 may further comprise a processing unit 204 to control functions of the computer 100. The processing unit 204 may control the I/O interface 208 to establish, operate and terminate connections with peripheral devices such as the communication device 110. The processing unit 204 may exchange information with the communication device 110 by controlling transmission and reception of information signals through the I/O interface 208. The processing unit 212 may be implemented by a digital signal processor with suitable software embedded in a computer readable medium, or by separate logic circuits, for example with ASIC (Application Specific Integrated Circuit).

The computer 100 may additionally comprise a user interface 202 for interaction with a user of the computer 100. The user interface 202 may comprise a display unit, a keypad or a keyboard, a loudspeaker, etc. The computer 100 may further comprise a memory unit 206 to store information processed by the processing unit 204.

As mentioned above, the connection between the computer 100 and the communication device 110 may be a cable connection. The communication device 110 may be a device configured simply to convey data between the computer 100 (or another electronic device connected to the I/O interface 210 of the communication device 110) and the mobile telecommunication network. The processing unit 212 of the communication device 100 may be configured to detect when the I/O interface 210 is connected to the computer 100 and, as a response, automatically carry out a process to register the communication device 110 to the mobile telecommunication network and establish a highspeed connection to a packet data network of the mobile telecommunication network. Once the registration process has been completed, the communication device 110 may start to convey data received from the computer 100 to the mobile telecommunication network and vice versa. Additionally, the communication device 110 may exchange with the serving base station 220 of the mobile telecommunication network information and control signals related to the management of a radio connection between the communication device 110 and the serving base station 220.

When the processing unit 212 of the communication device 110 detects a disconnection in the communication link with the computer 100, the processing unit 212 may be configured to start a deregistration process to deregister the communication device 110 from the mobile telecommunication network. The deregistration process according to an embodiment of the invention will be described later.

Accordingly, the communication device 110 mail be a “black box” configured to establish and terminate the radio connection with the mobile telecommunication network automatically when the processing unit 212 detects connection or disconnection with the computer.

A problem with cable connections in which at least one end of the cable is simply plugged into a port without any locking mechanism is that the cable may be removed accidentally from the port. In such case, a conventional communication device deregisters itself automatically from the mobile telecommunication network. When the cable is attached again, the conventional communication device registers itself to the mobile telecommunication network again. This causes unnecessary signaling between the conventional communication device and the mobile telecommunication network.

The communication device 110 according to an embodiment of the invention, on the contrary, does not immediately deregister itself from the mobile telecommunication network when it detects a disconnection between the communication device 110 and the computer 100. Instead, the communication device 110 starts a deregistration process which eventually leads to deregistration of the communication device 110 from the mobile telecommunication network, unless the connection between the communication device 110 and the computer 100 is re-established.

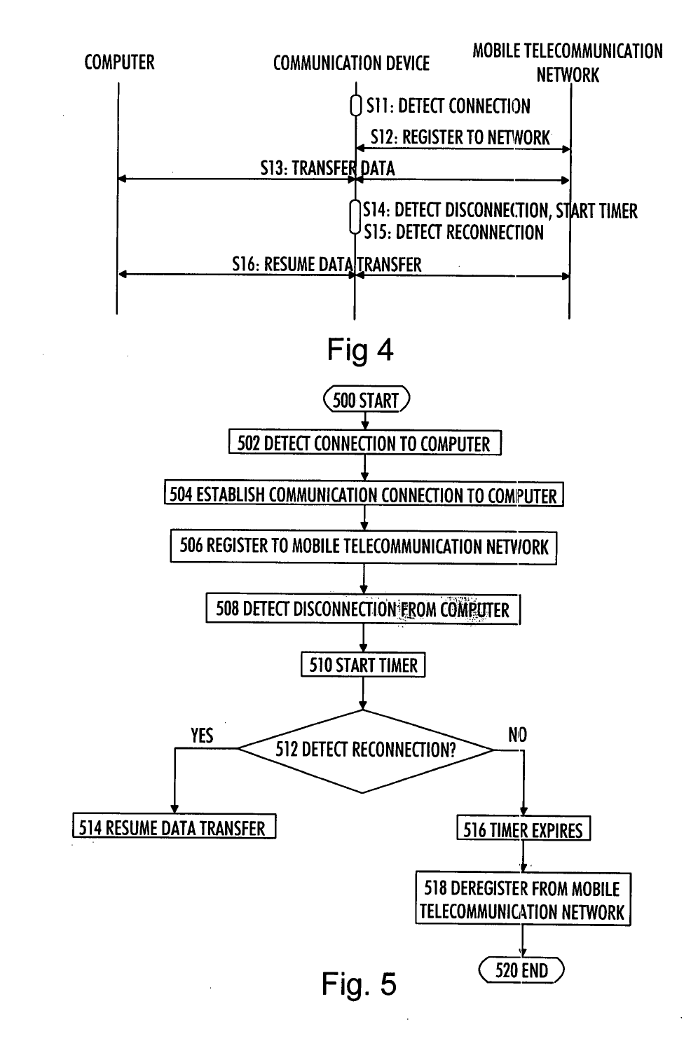

The deregistration process will be described next with reference to signaling diagrams of FIGS. 3 and 4. Referring to FIG. 3, the communication device 110 is connected to the computer 100 with a cable connection and, as a result, in S1 the communication device 110 detects the connection between the computer 100 and the communication device 110. As a consequence, the communication device 110 and the computer 100 may exchange information necessary for the establishment of the communication connection between the communication device 110 and the computer 100.

Upon detection of the connection between the I/O interface 210 of the communication device 110 and the computer in S1, the communication device 110 performs in S2 an operation to register itself to the mobile telecommunication network, i.e. to establish a communication connection between the communication interface 214 of the communication device 110 and the mobile telecommunication network. In this step, the communication device 110 may carry out signaling with the mobile telecommunication network through a base station providing a high-speed packet radio service in the area where the communication device 110 is located. The signaling between the base station and the communication device 110 may be carried out according to a procedure known in the art. As a consequence, the registration process to establish the communication connection between the communication device 110 and the mobile telecommunication network does not limit the invention.

When the communication connection between the communication device 110 and the mobile telecommunication network has been established, i.e. S2 has been completed, the communication device 110 is ready to convey data from the computer 100 to the mobile telecommunication network and from the mobile telecommunication network to the computer 100. In S3, data is transferred between the computer 100 and the communication device 110 and between the communication device 110 and the mobile telecommunication network.

While the communication device 110 is registered to the mobile telecommunication network, the connection between the computer 100 and the communication device 110 is suddenly disconnected. The disconnection may be a physical disconnection caused by a removal of the cable connecting the two devices 100 and 110. In S4, the processing unit 212 or the communication device 110 detects the disconnection between the communication device 110 and the computer 100. Upon detection of the disconnection between the communication device 110 and the computer 100, the processing unit 212 starts a timer (S4). The timer may have a predetermined duration in seconds. While the timer is running, the communication device 110 may maintain the communication connection with the mobile telecommunication network.

In S5, the timer expires indicating that the predetermined time period counted by the timer has elapsed from the start of the timer. As a result, the communication device 110 initiates in S6 a procedure to deregister itself from the mobile telecommunication network. Accordingly, the communication device 110 signals a deregistration request to the mobile telecommunication network and exchanges with the mobile telecommunication network information necessary for the deregistration. The deregistration process may be carried out according to a procedure known in the art. After the deregistration has been completed, the communication device 110 may shut down.

FIG. 4 illustrates a signaling diagram for a case in which a user of the computer 100 and the communication device 110 re-establishes the connection between the communication device 110 and the computer 100 before the expiration of the timer. Steps S11, S12, S13, and S14 are similar to steps S1, S2, S3, and S4 of FIG. 3. Accordingly, the processing unit 212 of the communication device 110 detects in S11 the connection between the communication device 110 and the computer 100. In S12, the communication device 110 registers itself to the mobile telecommunication network, and data is transferred between the computer 100 and the communication device 110 and between the communication device 110 and the mobile telecommunication network in S13. In S14, the processing unit 212 detects a disconnection between the computer 100 and the communication device 110 and starts the timer. The computer 100 may also detect the disconnection between the computer 100 and the communication device 110 and give an indication of the disconnection in the user interface 202 of the computer 100. The communication device 110 may also comprise means for indicating a detected disconnection between the communication device 110 and the computer 100. The communication device 110 may, for example, comprise a light-emitting device which is activated as a response to the detection of the disconnection.

Before the pre-determined time period counted by the timer elapses, the user re-establishes the cable connection between the computer 100 and the communication device 110 and, as a consequence, the processing unit 212 of the communication device 110 detects the reconnection between the computer 100 and the communication device 110. Since the pre-determined time period has not yet elapsed, the communication device 110 has not deregistered itself from the mobile telecommunication network, i.e. the connection between the communication device 110 and the mobile telecommunication network is maintained during the disconnection between the computer 100 and the communication device 110. Therefore, data transfer between the computer 100 and the communication device 110 and between the communication device 110 and the mobile telecommunication network is resumed in S16.

The time period counted by the timer may be long enough to enable the user of the computer 100 and the communication device 110 to reestablish the connection between the communication device 110 and the computer, i.e. to reconnect the removed cable. For this purpose, the time period may be a few seconds, for example five to ten seconds.

As mentioned in the above description, the communication device 110 may receive electrical power necessary for the operation of the communication device 110 from the computer 100 through the cable (USB) connection. When the cable is removed, power supply from the computer 100 ceases. Therefore, the communication device 110 may be provided with a battery to enable the operation of the communication device 110 after the cable has been removed. Consequently, the communication device 110 may obtain the power necessary for the detection of the disconnection, operation of the timer, the deregistration process, and other processes from the battery. The battery may be charged when the communication device 110 is again connected to the computer 100.

As mentioned above, the communication device 110 maintains the communication connection with the mobile telecommunication network after it has detected the disconnection from the computer 100 and before the predetermined time period counted by the timer has elapsed. During this time period, the communication device 110 may carry out data transfer with the mobile telecommunication network by transmitting data packets received from the computer 100 and buffered into a buffer memory unit of the communication device 110 for transmission to the mobile telecommunication network. Correspondingly, the communication device 110 may receive data packets from the mobile telecommunication network. The communication device 110 may buffer the received data packets into the buffer memory unit in case the connection with the computer 100 is re-established before the expiry of the timer. If the connection with the computer 100 is re-established before the expiry of the timer, the communication device 110 may send the buffered data packets to the computer 100. On the other hand, if the timer expires before the connection with the computer 100 is re-established, the communication device 110 may discard the buffered data packets.

Alternatively, the communication device 110 may suspend data traffic between the communication device and the mobile telecommunication network as a response to the detection of the disconnection between the electronic device and the communication device 110. The data packets may be buffered for transmission to the mobile telecommunication network in the buffer memory unit until the connection with the computer is re-established or the timer expires.

As mentioned above, when the communication device 110 detects a disconnection between the communication device 110 and the computer 100, it starts the timer and eventually deregisters itself from the mobile telecommunication network, unless it detects a reconnection. This procedure may occur in a situation where the processing unit 212 of the communication device 110 detects the disconnection. On the other hand, when the processing unit 212 receives a disconnection command from the computer 100 through the I/O interface 210, it may immediately deregister itself from the mobile telecommunication network and shut down. The disconnection command may be initiated by the user of the computer 100 through the user interface 202 of the computer 100. For this type of controlled disconnection between the computer 100 and the communication device 110 there may be no need for delayed deregistration.

Next, a process for controlling the operation of the communication device 110 is described with reference to a flow diagram in FIG. 5. The operation of the communication device 110 may be controlled by the processing unit 212 configured with software. The process starts in block 500.

In block 502, a connection between the communication device 110 and the computer 100 is detected. The processing unit 212 may detect the connection between the I/O interface 210 of the communication device 110 and the computer 100 when the user has connected the communication device 110 to the computer 100 through a cable.

In block 504, the processing unit 212 negotiates a communication connection with the computer 100. From the point of view of the computer 100, the communication device 110 may function as a network adapter and the computer 100 and the communication device 110 may communicate according to the RNDIS.

In block 506, the processing unit 212 establishes a communication connection between the communication interface 214 of the communication device 110 and the mobile telecommunication network. Accordingly, the communication device 110 is registered to the mobile telecommunication network. After the registration process has been completed, the communication device 110 may start conveying data packets between the computer 100 and the mobile telecommunication network.

In block 508, the processing unit 212 detects a disconnection between the I/O interface 210 and the computer 100. The processing unit 212 may detect the disconnection from the fact that no electric power is received from the computer 100 anymore or that the communication device 110 can no longer exchange data with the computer 100.

As a response to the detection of the disconnection between the I/O interface 210 and the computer 100, the processing unit 212 starts in block 510 a timer counting a pre-determined time period. In block 512, it is checked whether or not the processing unit 212 detects a reconnection between the I/O interface 210 and the computer 100 before the pre-determined time period counted by the timer has elapsed. The processing unit 212: may detect the reconnection from the fact that electric power is again received from the computer 100 or that the communication device 110 can again exchange data with the computer 100.

If the processing unit 212 detects the reconnection before the predetermined time period has elapsed, the process moves to block 514 in which the processing unit 212 resumes data transfer with the computer 100. If the processing unit 212 had suspended data transfer with the mobile telecommunication network when it detected the disconnection between the I/O interface 210 and the computer 100, it may in block 514 resume the data transfer with the mobile telecommunication network, too.

If the processing unit 212 does not detect a reconnection before the pre-determined time period has elapsed, the process moves to block 516 in which the timer expires to indicate that the pre-determined time period from the start of the timer has elapsed. As a consequence, the processing unit 212 performs an operation to disconnect the communication connection between the communication device 110 and the mobile telecommunication network in block 518. The operation includes deregistration of the communication device 110 from the mobile telecommunication network. The processing unit 212 may also control an operation to shut down the communication device 110. The process ends in block 520.

The embodiments of the invention may be realized in the communication device 110 comprising the I/O interface 210, the communication interface 214, and the processing unit 212 operationally connected to the I/O interface 210 and the communication interface 214. The processing unit 212 may be configured to perform at least some of the steps described in connection with the flowchart of FIG. 5 and in connection with FIGS. 3 and 4. The embodiments may be implemented as a computer program comprising instructions for executing a computer process for controlling the operation of the communication device 110.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but it can be modified in several ways within the scope of the appended claims.

1. A method, comprising:
detecting a disconnection between an electronic: device and a communication device providing the electronic device with a communication connection to a mobile telecommunication network;
starting a timer upon detection of the disconnection between the electronic device and the communication device; and
performing an operation to disconnect the communication connection between the communication device and the mobile telecommunication network after a lapse of a pre-determined time period counted by the timer.

2. The method according to claim 1, further comprising:
maintaining the communication connection between the communication device and the mobile telecommunication network, if a reconnection between the electronic device and the communication device is detected before the lapse of the pre-determined time period.

3. The method according to claim 1, further comprising:
detecting a connection between the electronic device and the communication device in a state in which the communication device is not connected to the mobile telecommunication network; and
registering the communication device to the mobile telecommunication network upon detection of the connection between the electronic device and the communication device.

4. The method according to claim 1, further comprising:
maintaining the communication connection between the communication device and the mobile telecommunication network for the predetermined time period after the detection of the disconnection between the electronic device and the communication device.

5. The method according to claim 4, further comprising:
transferring data packets between the communication device and the mobile telecommunication network regardless of the detection of the disconnection between the electronic device and the communication device.

6. The method according to claim 4, further comprising:
suspending data traffic between the communication device and the mobile telecommunication network as a response to the detection of the disconnection between the electronic device and the communication device.

7. The method according to claim 1, wherein the connection between the electronic device and the communication devices is a physical connection and the connection between the communication device and the mobile telecommunication network is a wireless connection.

8. The method according to claim 7, wherein the connection between the communication device and the mobile telecommunication network is a high-speed packet radio connection.

9. The method according to claim 7, wherein the connection between the electronic device and the communication device is a wired connection, the method further comprising:
providing the communication device with power, through the wired connection for the operation of the communication device.

10. The method according to claim 9, further comprising:
obtaining the power required for the operation of the communication device from a battery during a disconnection from the electronic device.

11. The method according to claim 1, wherein the communication device functions as a network adapter for the communication with the electronic device and as a terminal of the mobile telecommunication network for packet radio communications with the mobile telecommunication network.

12. The method according to claim 1, wherein the electronic device is a computer and the communication device is an external peripheral device.

13. The method according to claim 1, wherein the operation to disconnect the communication connection between the communication device and the mobile telecommunication network comprises deregistering the communication device from the mobile telecommunication network.

14. An apparatus, comprising:
a first interface configured to provide a connection to an electronic device;
a second interface configured to provide a connection to a mobile telecommunication network: and
a processing unit configured to detect a disconnection in a first interface, start a timer upon detection of the disconnection in the first interface, and perform an operation to disconnect the second interface from the mobile telecommunication network after a lapse of a pre-determined time period counted by the timer.

15. The apparatus according to claim 14, wherein the processing unit is further configured to maintain the connection between the second interface and the mobile telecommunication network, if a reconnection between the first interface and the electronic device is detected before the lapse of the predetermined time period.

16. The apparatus according to claim 14, wherein the processing unit is further configured to detect a connection between the electronic device and the first interface in a state in which the second interface is not connected to the mobile telecommunication network, and configured to connect the second interface to the mobile telecommunication network by registering the apparatus to the mobile telecommunication network upon detection of the connection between the electronic device and the first interface.

17. The apparatus according to claim 14, wherein the processing unit is further configured to maintain the connection between the second interface and the mobile telecommunication network for the pre-determined time period after the detection of the disconnection between the electronic device and the first interface.

18. The apparatus according to claim 17, wherein the processing unit is further configured to transfer data packets between the second interface and the mobile telecommunication network regardless of the detection of the disconnection between the electronic device and the first interface.

19. The apparatus according to claim 17, wherein the processing unit is further configured to suspend data traffic between the second interface and the mobile telecommunication network as a response to the detection of the disconnection between the electronic device and the first interface.

20. The apparatus according to claim 14, wherein the connection between the electronic device and the first interface is a Wired connection and the connection between the second interface and the mobile telecommunication network is a wireless connection.

21. The apparatus according to claim 20, wherein the connection between the second interface and the mobile telecommunication network is a high-speed packet radio connection.

22. The apparatus according to claim 20, wherein the apparatus is configured to receive power through the wired connection for the operation of the apparatus.

23. The apparatus according to claim 22, wherein the apparatus further comprises a battery to provide the apparatus with the power required for the operation of the apparatus during a disconnection from the electronic device.

24. The apparatus according to claim 14, wherein the operation to disconnect the communication connection between the communication device and the mobile telecommunication network comprises deregistering the communication device from the mobile telecommunication network.

25. An arrangement, comprising:
an electronic device comprising an interface to provide a communication connection with peripheral devices and a processing unit configured to control the operations of the electronic device: and
a communication device comprising a first interface to provide a connection to the electronic device, a second interface to provide a connection to a mobile telecommunication network, and a processing unit configured to detect a disconnection in the connection with the electronic device, start a timer upon detection of the disconnection in the connection with the electronic device, and perform an operation to disconnect the second interface from the mobile telecommunication network after a lapse of a pre-determined time period counted by the timer.

26. An apparatus, comprising:
means for detecting a disconnection between in electronic device and a communication device;
means for providing the electronic device with a communication connection to a mobile telecommunication network;
means for starting a timer upon detection of the disconnection between the electronic device and the communication device: and means for performing an operation to disconnect the communication connection between the communication device and the mobile telecommunication network after a lapse of a pre-determined time period counted by the timer.

27. A computer program distribution medium readable by a computer and encoding a computer program of instructions for executing a computer process comprising:
detecting a disconnection between an electronic: device and a communication device providing the electronic device with a communication connection to a mobile telecommunication network;
starting a timer upon detection of the disconnection between the electronic device and the communication device: and
performing an operation to disconnect the communication connection between the communication device and the mobile telecommunication network after a lapse of a pre-determined time period counted by the timer.

28. The computer program distribution medium of claim 27, the distribution medium including at least one of the following media: a computer readable medium, a program storage medium, a record medium, a computer readable memory, a computer readable software distribution package, a computer readable signal, a computer readable telecommunications signal, and a computer readable compressed software package.
